(19) United States
(12) Patent Application Publication
(10) Pub. No.: US 2026/0264194 A1
(43) Pub. Date: Sep. 10, 2026

(54) METHOD AND APPARATUS FOR CALCULATING GRINDING ALLOWANCE OF WORKPIECE IN LASER CLADDING ADDITIVE MANUFACTURING

(71) Applicants: China Academy Of Machinery Wuhan Research Institute Of Materials Protection Co.,Ltd., WUHAN (CN); HUAZHONG UNIVERSITY OF SCIENCE AND TECHNOLOGY, WUHAN (CN)

(72) Inventors: DAN JIA, WUHAN (CN); XIAOSHUANG LUO, WUHAN (CN); WENXUAN LI, WUHAN (CN); BO SONG, WUHAN (CN); LIXIN MA, WUHAN (CN); SHUO LIU, WUHAN (CN)

(21) Appl. No.: 19/403,513

(22) Filed: Nov. 28, 2025

(30) Foreign Application Priority Data
Mar. 5, 2025 (CN) 202510254256.3

(51) Int. Cl. B24B 49/03; B33Y 50/00

(52) U.S. Cl. CPC B24B 49/03; B33Y 50/00

(57) ABSTRACT

This invention provides a method and apparatus for calculating grinding allowance of workpiece in laser cladding additive manufacturing. The method involves acquiring first and second point cloud data of a workpiece before and after grinding, respectively. An unground portion is identified from this data and registered to obtain a transformation matrix. Applying this matrix to the first point cloud data yields a registered third point cloud. The third and second point clouds are then projected onto respective fitting planes to generate first and second discrete projection point sets. B-spline curves are fitted to these point sets. Finally, the grinding allowance is calculated based on the distance from points on the first B-spline curve to the tangent lines at corresponding points on the second B-spline curve. This approach utilizes laser 3D measurement and point cloud registration for non-contact measurement, effectively improving workpiece quality and reducing material waste during grinding.

### FIELD OF THE DISCLOSURE

The present invention relates to the field of industrial processing technology, and in particular, to a method and apparatus for calculating grinding allowance of workpiece in laser cladding additive manufacturing.

### BACKGROUND

Workpieces with complex geometric shapes typically have characteristics such as thin-walled structures, complex curvatures, and poor machinability. During processing, surface roughness and allowance of the workpiece need to be strictly controlled. For example, the thickness of a thermal barrier coating for a turbine blade is generally 150-350 μm, with limited machining allowance. Excessive grinding can result in an overly thin coating that impairs performance, whereas insufficient grinding may not meet surface quality requirements. For other complex components, surface machining consistency and precise allowance control are also key challenges.

Currently, methods for reducing the surface roughness of complex workpieces mainly include manual tool processing, vibration finishing, and abrasive flow machining. However, these machining methods have shortcomings in processing efficiency and consistency.

### SUMMARY

Embodiments of the present invention provide a method, apparatus, storage medium, and electronic device for calculating grinding allowance of workpiece in laser cladding additive manufacturing, which enhances the accuracy of calculating the grinding allowance of the workpiece, reduce material waste, and effectively enhance workpiece processing quality.

An embodiment of the present invention provides a method for calculating grinding allowance of workpiece in laser cladding additive manufacturing, comprising:
acquiring first point cloud data of a workpiece before grinding and second point cloud data of the workpiece after grinding;
obtaining an unground portion based on the first point cloud data and the second point cloud data, and performing registration on the unground portion to obtain a transformation matrix;
obtaining registered third point cloud data based on the first point cloud data and the transformation matrix;
projecting the third point cloud data and the second point cloud data to obtain a first discrete projection point set and a second discrete projection point set;
performing B-spline curve fitting on the first discrete projection point set and the second discrete projection point set to obtain a first B-spline curve and a second B-spline curve;
calculating the grinding allowance based on the first B-spline curve and the second B-spline curve.

As a further improvement of the present invention, in the above method for calculating grinding allowance of workpiece in laser cladding additive manufacturing, projecting the third point cloud data and the second point cloud data to obtain a first discrete projection point set and a second discrete projection point set, comprises:
randomly selecting a plurality of points in the third point cloud data to calculate a corresponding first plane equation;
generating a first auxiliary plane and a second auxiliary plane based on a first fitting plane corresponding to the first plane equation;
counting the number of point clouds contained in a space between the first auxiliary plane and the first fitting plane, and in a space between the second auxiliary plane and the first fitting plane;
traversing point clouds in the space on the side with a smaller number of point clouds, and for any point pᵢ, finding a nearest neighbor point pⱼ of pᵢ in the point clouds on the other side, connecting pᵢpⱼ, and calculating an intersection point of pᵢpⱼ with the first fitting plane as a projection point;
repeating the above steps to obtain a plurality of projection points, forming the first discrete projection point set.

As a further improvement of the present invention, in the above method for calculating grinding allowance of workpiece in laser cladding additive manufacturing, projecting the third point cloud data and the second point cloud data to obtain a first discrete projection point set and a second discrete projection point set, comprises:
randomly selecting a plurality of points in the second point cloud data to calculate a corresponding second plane equation;
generating a third auxiliary plane and a fourth auxiliary plane based on a second fitting plane corresponding to the second plane equation;
counting the number of point clouds contained in a space between the third auxiliary plane and the second fitting plane, and in a space between the fourth auxiliary plane and the second fitting plane;
traversing point clouds in the space on the side with a smaller number of point clouds, and for any point qᵢ, finding a nearest neighbor point qⱼ of qᵢ in the point clouds on the other side, connecting qᵢqⱼ, and calculating an intersection point of qᵢqⱼ with the second fitting plane as a projection point;
repeating the above steps to obtain a plurality of projection points, forming the second discrete projection point set.

As a further improvement of the present invention, in the above method for calculating grinding allowance of workpiece in laser cladding additive manufacturing, generating a first auxiliary plane and a second auxiliary plane based on a first fitting plane corresponding to the first plane equation comprises:
using the first fitting plane corresponding to the first plane equation as a reference, translating the first fitting plane by a first distance toward both sides respectively to obtain the first auxiliary plane and the second auxiliary plane.

As a further improvement of the present invention, in the above method for calculating grinding allowance of workpiece in laser cladding additive manufacturing, performing B-spline curve fitting on the first discrete projection point set and the second discrete projection point set to obtain a first B-spline curve and a second B-spline curve, comprises:
for the second discrete projection point set, setting an order k and a node vector {u₀, u₁, . . . , uₘ}, and establishing a B-spline curve equation:

$$C ( u ) = {{\sum }_{i = 0}}^{n} {P}_{i} {B}_{i , k} ( u )$$

wherein, Pᵢ is a control point, B_{i,k}(u) is a B-spline basis function, the length of the node vector is m+1, the number of control points n+1 and the order k have the following relationship:

$$m = n + k + 1$$

a recursive relation for the basis function B_{i,k}(u) of any order k is:

$${B}_{i , k} ( u ) = \frac{u - {u}_{i}}{{u}_{i + {k}^{-}} {u}_{i}} {B}_{i , k - 1} ( u ) + \frac{{u}_{i + k + {1}^{-}} u}{{u}_{i + k + {1}^{-}} {u}_{i + 1}} {B}_{i + 1 , k - 1} ( u )$$

defining an error calculation function E:

$$E = {\sum }_{j = 1}^{m} {‖ {Q}_{j} - C ( {u}_{j} ) ‖}^{2}$$

using a least squares method to optimize the control points {Pᵢ}, to obtain the second B-spline curve C(u).

As a further improvement of the present invention, in the above method for calculating grinding allowance of workpiece in laser cladding additive manufacturing, calculating the grinding allowance based on the first B-spline curve and the second B-spline curve, comprises: selecting a plurality of uniformly distributed parameter values on the first B-spline curve and the second B-spline curve, and determining a first corresponding point on the first B-spline curve and a second corresponding point on the second B-spline curve for each parameter value; determining a tangent direction at the second corresponding point;
calculating a distance from the first corresponding point to the tangent line at the second corresponding point as the grinding allowance of the first corresponding point;
repeating the above steps to calculate the grinding allowance for all sampling points, obtaining a complete grinding allowance of the workpiece.

As a further improvement of the present invention, in the above method for calculating grinding allowance of workpiece in laser cladding additive manufacturing, calculating a distance from the first corresponding point to the tangent line at the second corresponding point as the grinding allowance of the first corresponding point, comprises:
calculating the grinding allowance using a first formula, the first formula being:

$${d}_{i} = ‖ D - ( D \cdot t ) \cdot t ‖$$

wherein, D=qᵢ−pᵢ, qᵢ is the first corresponding point, pᵢ is the second corresponding point, dᵢ is the grinding allowance, and t is the tangent direction at the second corresponding point.

The embodiments of the present invention further provide an apparatus for calculating grinding allowance of workpiece in laser cladding additive manufacturing, comprising:
a point cloud acquisition module, configured to acquire first point cloud data of a workpiece before grinding and second point cloud data of the workpiece after grinding;
a first processing module, configured to obtain an unground portion based on the first point cloud data and the second point cloud data, and perform registration on the unground portion to obtain a transformation matrix;
a second processing module, configured to obtain registered third point cloud data based on the first point cloud data and the transformation matrix;
a projection module, configured to project the third point cloud data and the second point cloud data to obtain a first discrete projection point set and a second discrete projection point set;
a B-spline curve fitting module, configured to perform B-spline curve fitting on the first discrete projection point set and the second discrete projection point set to obtain a first B-spline curve and a second B-spline curve;
a grinding allowance calculation module, configured to calculate the grinding allowance based on the first B-spline curve and the second B-spline curve.

The embodiments of the present invention further provide a computer-readable storage medium, the computer-readable storage medium storing a plurality of instructions, the instructions being adapted to be loaded by a processor to execute the method for calculating grinding allowance of workpiece in laser cladding additive manufacturing according to any one of the above.

The embodiments of the present invention further provide an electronic device, comprising a processor and a memory, the processor being electrically connected to the memory, the memory being configured to store instructions and data, and the processor being configured to execute the steps in the method for calculating grinding allowance of workpiece in laser cladding additive manufacturing according to any one of the above.

The method, apparatus, storage medium, and electronic device for calculating grinding allowance of workpiece in laser cladding additive manufacturing provided by the present invention are based on first point cloud data of a workpiece before grinding and second point cloud data of the workpiece after grinding to perform point cloud registration, projection, and B-spline curve fitting to calculate the grinding allowance of the workpiece. Non-contact measurement during the grinding process of the workpiece is achieved through laser three-dimensional measurement and a point cloud registration algorithm, effectively improving workpiece processing quality while reducing material waste. In addition, combined with three-dimensional point cloud data of the workpiece, the present invention can achieve path planning during the grinding process and improve processing technology.

### BRIEF DESCRIPTION OF THE FIGURES

The technical solutions and other beneficial effects of the present invention will become apparent through the following detailed description of specific embodiments with reference to the accompanying drawings.

FIG. 1 is a flowchart of a method for calculating grinding allowance of workpiece in laser cladding additive manufacturing provided by the present invention.

FIG. 2 is a schematic diagram of a fitting plane and auxiliary planes provided by the present invention.

FIG. 3 is a structural diagram of an apparatus for calculating grinding allowance of workpiece in laser cladding additive manufacturing provided by the present invention.

FIG. 4 is a structural diagram of an electronic device provided by the present invention.

### DETAILED DESCRIPTION

The technical solutions in the embodiments of the present invention will be clearly and completely described below with reference to the accompanying drawings in the embodiments of the present invention. Obviously, the described embodiments are only a part of the embodiments of the present invention, and not all of them. Based on the embodiments in the present invention, all other embodiments obtained by those of ordinary skill in the art without creative work shall fall within the protection scope of the present invention.

With the development of automation and intelligent technology, robot control and multi-axis machining systems are gradually applied to high-precision machining of complex workpieces, providing higher accuracy and flexibility for surface allowance consistency control and quality optimization. In the process of using robots to achieve surface grinding of complex workpieces, it is necessary to accurately measure and reasonably control the surface allowance to ensure machining consistency and surface quality. Excessive grinding may lead to excessive local material removal, affecting workpiece performance or structural integrity; while insufficient grinding cannot effectively reduce the surface roughness of the workpiece to meet the requirements of high-precision inventions. Therefore, an embodiment of the present invention provides a method, apparatus, storage medium, and electronic device for calculating grinding allowance of workpiece in laser cladding additive manufacturing. An apparatus for calculating grinding allowance of workpiece in laser cladding additive manufacturing provided by an embodiment of the present invention can be integrated in an electronic device, which can be a terminal, a server, or other devices, wherein the terminal can include a tablet computer, a laptop computer, a personal computer (PC), a micro-processing box, or other devices.

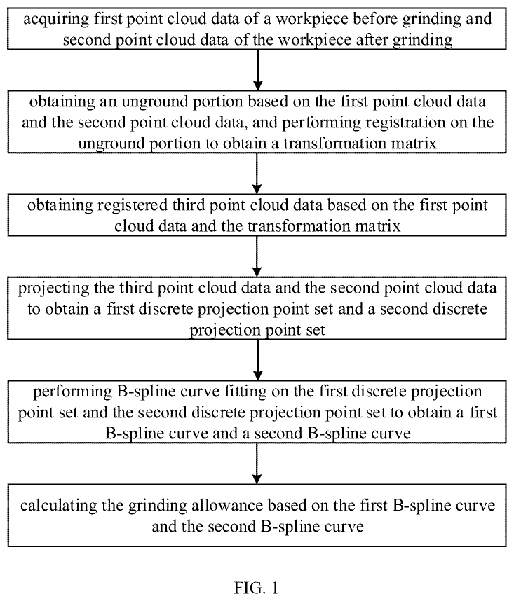

Please refer to FIG. 1, which is a flowchart of a method for calculating grinding allowance of workpiece in laser cladding additive manufacturing provided by the present invention. The method is applied to an electronic device and includes the following steps:

S1, acquiring first point cloud data of a workpiece before grinding and second point cloud data of the workpiece after grinding.

Specifically, use a line laser scanner to acquire first point cloud data P of a workpiece substrate before grinding and second point cloud data Q of the workpiece after grinding.

S2, obtaining an unground portion based on the first point cloud data and the second point cloud data, and performing registration on the unground portion to obtain a transformation matrix.

Specifically, subtract the first point cloud data P and the second point cloud data Q to obtain point cloud data of the unground portion, and use a registration algorithm on the point cloud data of the unground portion to calculate a transformation matrix T.

S3, obtaining registered third point cloud data based on the first point cloud data and the transformation matrix.

Specifically, apply the transformation matrix T to the first point cloud data P to obtain registered third point cloud data P′.

S4: projecting the third point cloud data and the second point cloud data to obtain a first discrete projection point set and a second discrete projection point set.

In one embodiment, S4 includes the following steps:
S411, randomly selecting a plurality of points in the third point cloud data to calculate a corresponding first plane equation;
S412, generating a first auxiliary plane and a second auxiliary plane based on a first fitting plane corresponding to the first plane equation;
Specifically, using the first fitting plane corresponding to the first plane equation as a reference, translating the first fitting plane by a first distance toward both sides respectively to obtain the first auxiliary plane and the second auxiliary plane.

S413, counting the number of point clouds contained in a space between the first auxiliary plane and the first fitting plane, and in a space between the second auxiliary plane and the first fitting plane;

S414, traversing point clouds in the space on the side with a smaller number of point clouds, and for any point pᵢ, finding a nearest neighbor point pⱼ of pᵢ in the point clouds on the other side, connecting pᵢpⱼ, and calculating an intersection point of pᵢpⱼ with the first fitting plane as a projection point;

S415, repeating the above steps to obtain a plurality of projection points, forming the first discrete projection point set.

S421, randomly selecting a plurality of points in the second point cloud data to calculate a corresponding second plane equation;
S422, generating a third auxiliary plane and a fourth auxiliary plane based on a second fitting plane corresponding to the second plane equation;
S423, counting the number of point clouds contained in a space between the third auxiliary plane and the second fitting plane, and in a space between the fourth auxiliary plane and the second fitting plane;
S424, traversing point clouds in the space on the side with a smaller number of point clouds, and for any point qᵢ, finding a nearest neighbor point q of qᵢ in the point clouds on the other side, connecting qᵢqⱼ, and calculating an intersection point of qᵢqⱼ with the second fitting plane as a projection point;
S425, repeating the above steps to obtain a plurality of projection points, forming the second discrete projection point set.

Specifically, the slice projection process for the third point cloud data P′ is as follows:

Use a Random Sample Consensus (RANSAC) algorithm to calculate a first plane equation Ax+By+Cz=D based on three randomly selected points. Set a plane distance threshold, continuously iterate and count the number of inliers until a plane parameter model with the maximum number of inliers is obtained.

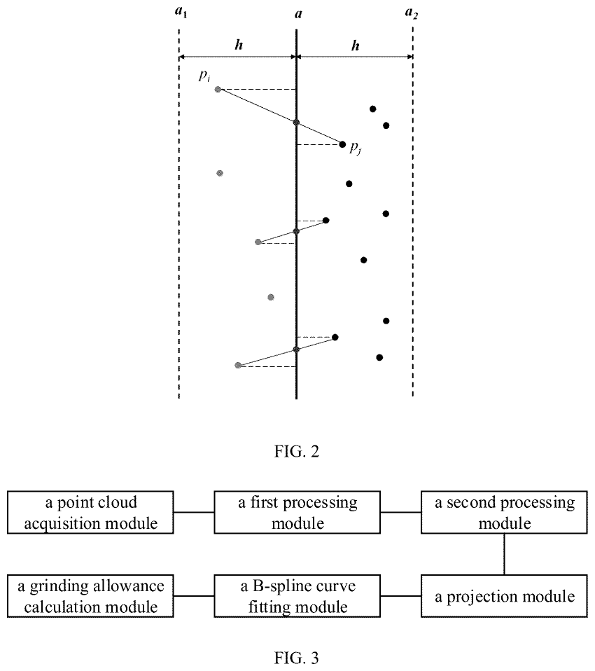

Then, using the first fitting plane a as a reference, translate by a distance h to generate a first auxiliary plane a1 and a second auxiliary plane a2. FIG. 2 is a schematic diagram of a fitting plane and auxiliary planes provided by the present invention, as shown in FIG. 2. Count the number of point clouds contained in the subspaces ala and aa2 on both sides of plane a. Traverse the point clouds on the side with a smaller number, and for any point pᵢ therein, find its nearest neighbor point pⱼ in the point clouds on the other side, connect pᵢpⱼ and calculate its intersection point with plane a as a projection point.

Similarly, perform the above steps on point cloud Q, and finally obtain a first discrete projection point set Pⱼ and a second discrete projection point set Qⱼ of the workpiece point clouds before and after grinding.

S5, performing B-spline curve fitting on the first discrete projection point set and the second discrete projection point set to obtain a first B-spline curve and a second B-spline curve.

Specifically, for the second discrete projection point set Qⱼ, setting an order k and a node vector {u₀, u₁, . . . , uₘ}, and establishing a B-spline curve equation:

$$C ( u ) = {\sum }_{i = 0}^{n} {P}_{i} {B}_{i , k} ( u )$$

wherein, Pᵢ is a control point, B_{i,k}(u) is a B-spline basis function, the length of the node vector is m+1, the number of control points n+1 and the order k have the following relationship:

$$m = n + k + 1$$

a recursive relation for the basis function B_{i,k}(u) of any order k is:

$${B}_{i , k} ( u ) = \frac{u - {u}_{i}}{{u}_{i + {k}^{-}} {u}_{i}} {B}_{i , k - 1} ( u ) + \frac{{u}_{i + k + {1}^{-}} u}{{u}_{i + k + {1}^{-}} {u}_{i + 1}} {B}_{i + 1 , k - 1} ( u )$$

defining an error calculation function E:

$$E = {\sum }_{j = 1}^{m} {‖ {Q}_{j} - C ( {u}_{j} ) ‖}^{2}$$

using a least squares method to optimize the control points {Pᵢ}, to obtain the second B-spline curve C(u).

Based on the above steps, perform fitting on point sets Pⱼ and Qⱼ respectively to obtain B-spline curves C_{P}(u) and C_{Q}(u).

S6, calculating the grinding allowance based on the first B-spline curve and the second B-spline curve.

In one embodiment, step S6 includes the following steps:

S61, selecting a plurality of uniformly distributed parameter values on the first B-spline curve and the second B-spline curve, and determining a first corresponding point on the first B-spline curve and a second corresponding point on the second B-spline curve for each parameter value.

S62, determining a tangent direction at the second corresponding point.

S63, calculating a distance from the first corresponding point to the tangent line at the second corresponding point as the grinding allowance of the first corresponding point.

Specifically, calculating the grinding allowance using a first formula, the first formula being:

$${d}_{i} = ‖ D - ( D \cdot t ) \cdot t ‖$$

wherein, D=qᵢ−pᵢ, qᵢ is the first corresponding point, pᵢ is the second corresponding point, dᵢ is the grinding allowance, and t is the tangent direction at the second corresponding point.

S64, repeating the above steps to calculate the grinding allowance for all sampling points, obtaining a complete grinding allowance of the workpiece.

Specifically, select a series of uniformly distributed parameter values u₁, u₂, . . . , uₖ on the curves C_{P}(u) and C_{Q}(u) For each parameter value uᵢ, the corresponding point on curve C_{P}(u) is pᵢ=C_{P}(uᵢ), calculate the tangent direction t=dC_{P}(u)/du|u=uᵢ at pᵢ, and calculate the distance from the corresponding point qᵢ on C_{Q}(u) to the tangent line at pᵢ as the grinding allowance dᵢ at that point, wherein D=qᵢ−pᵢ,

$${d}_{i} = ‖ D - ( D \cdot t ) \cdot t ‖ .$$

Calculate dᵢ for all sampling points to obtain a complete grinding allowance distribution of the workpiece.

It is to be noted that, after obtaining the grinding allowance of the workpiece, the grinding allowance of the workpiece may be compared with a preset allowance range to determine whether the grinding allowance of the workpiece exceeds the preset allowance range. If the grinding allowance exceeds the preset allowance range, an alert message is issued to prompt an operator to stop grinding the workpiece. Furthermore, the grinding allowance of the workpiece may be fed back to a process system to optimize process parameters for laser cladding or subsequent grinding.

The present invention achieves non-contact measurement during the grinding process of workpiece through laser three-dimensional measurement and point cloud registration algorithm, effectively improving workpiece processing quality while reducing material waste. In addition, combined with three-dimensional point cloud data of the workpiece, the present invention can achieve path planning during the grinding process and improve processing technology.

According to the method described in the above embodiments, this embodiment will further be described from the perspective of an apparatus for calculating grinding allowance of workpiece in laser cladding additive manufacturing. The apparatus can be implemented as an independent entity or integrated in an electronic device, which can be a terminal, a server, or other devices, wherein the terminal can include a tablet computer, a laptop computer, a personal computer (PC), a micro-processing box, or other devices.

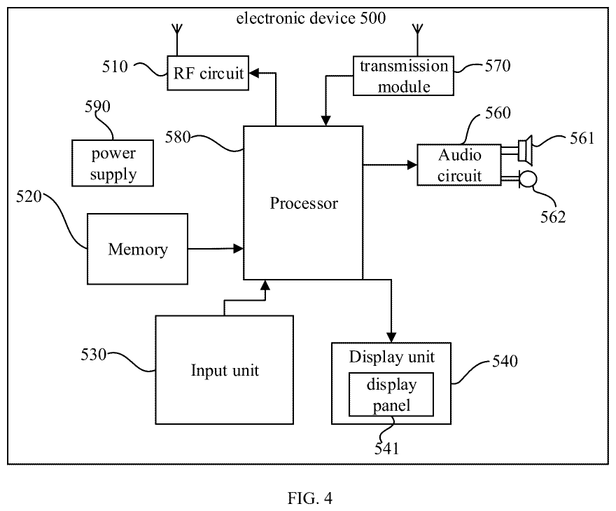

Please refer to FIG. 3, which specifically describes an apparatus for calculating grinding allowance of workpiece in laser cladding additive manufacturing provided by the present invention. The apparatus is applied to an electronic device and can include:
a point cloud acquisition module, configured to acquire first point cloud data of a workpiece before grinding and second point cloud data of the workpiece after grinding;
a first processing module, configured to obtain an unground portion based on the first point cloud data and the second point cloud data, and perform registration on the unground portion to obtain a transformation matrix;
a second processing module, configured to obtain registered third point cloud data based on the first point cloud data and the transformation matrix;
a projection module, configured to project the third point cloud data and the second point cloud data to obtain a first discrete projection point set and a second discrete projection point set;
a B-spline curve fitting module, configured to perform B-spline curve fitting on the first discrete projection point set and the second discrete projection point set to obtain a first B-spline curve and a second B-spline curve;
a grinding allowance calculation module, configured to calculate the grinding allowance based on the first B-spline curve and the second B-spline curve.

During specific implementation, each of the above modules and/or units can be implemented as independent entities, or combined arbitrarily as one or several entities. The specific implementation of each of the above modules and/or units can refer to the preceding method embodiments, and the achievable beneficial effects are also described in the preceding method embodiments, which will not be repeated here.

In addition, an embodiment of the present invention further provides an electronic device, which can be a computer, a tablet computer, or other devices. The electronic device can implement the steps in any embodiment of the method for calculating grinding allowance of workpiece in laser cladding additive manufacturing provided by the embodiments of the present invention. Therefore, it can achieve the beneficial effects achievable by any method for calculating grinding allowance of workpiece in laser cladding additive manufacturing provided by the embodiments of the present invention. For details, refer to the preceding embodiments, which will not be repeated here.

As shown in FIG. 4, which is a specific structural diagram of an electronic device provided by an embodiment of the present invention, the electronic device can be used to implement the method for calculating grinding allowance of workpiece in laser cladding additive manufacturing provided in the above embodiments. The electronic device 500 can be a terminal, a server, or other devices, wherein the terminal can include a tablet computer, a laptop computer, a personal computer (PC), a micro-processing box, or other devices.

RF circuit 510 is configured to receive and transmit electromagnetic waves, realize the mutual conversion between electromagnetic waves and electrical signals, and thus communicate with a communication network or other devices. RF circuit 510 may include various existing circuit components for performing these functions, such as an antenna, a radio frequency transceiver, a digital signal processor, an encryption/decryption chip, a subscriber identity module (SIM) card, a memory, etc. RF circuit 510 can communicate with various networks such as the Internet, an intranet, a wireless network, or communicate with other devices through a wireless network. The above-mentioned wireless network may include a cellular telephone network, a wireless local area network, or a metropolitan area network. The above-mentioned wireless network may use various communication standards, protocols, and technologies, including but not limited to Global System for Mobile Communication (GSM), Enhanced Data GSM Environment (EDGE), Wideband Code Division Multiple Access (WCDMA), Code Division Multiple Access (CDMA), Time Division Multiple Access (TDMA), Wireless Fidelity (Wi-Fi) (such as IEEE standards 802.11a, 802.11b, 802.11g, and/or 802.11n), Voice over Internet Protocol (VOIP), Worldwide Interoperability for Microwave Access (Wi-Max), other protocols for email, instant messaging, and short messages, and any other suitable communication protocols, even including those that are currently not yet developed.

Memory 520 can be used to store software programs and modules, such as the corresponding program instructions/modules in the above-mentioned embodiments. Processor 580 executes various functional inventions and data processing by running the software programs and modules stored in memory 520, that is, implementing functions such as front camera photography, processing of captured images, and switching display colors of content on the display screen. Memory 520 may include high-speed random access memory, and may also include non-volatile memory, such as one or more magnetic storage devices, flash memory, or other non-volatile solid-state memory. In some instances, memory 520 may further include memories remotely located relative to processor 580, and these remote memories may be connected to the electronic device 500 through a network. Examples of the above-mentioned network include but are not limited to the Internet, an intranet, a local area network, a mobile communication network, and combinations thereof.

Input unit 530 can be used to receive input numeric or character information and generate keyboard, mouse, and other key signal inputs related to user settings and function control.

Display unit 540 can be used to display information input by the user or information provided to the user and various graphical user interfaces, which may be composed of graphics, text, icons, videos, and any combination thereof. Display unit 540 may include a display panel 541. Optionally, the display panel 541 may be configured in the form of LCD (Liquid Crystal Display), OLED (Organic Light-Emitting Diode), etc.

Audio circuit 560, speaker 561, and microphone 562 can provide an audio interface between the user and the electronic device 500. Audio circuit 560 can convert received audio data into an electrical signal and transmit it to speaker 561, which converts it into a sound signal for output; on the other hand, microphone 562 converts collected sound signals into electrical signals, which are received by audio circuit 560 and converted into audio data, then the audio data is output to processor 580 for processing and then transmitted via RF circuit 510 to, for example, another terminal, or the audio data is output to memory 520 for further processing. Audio circuit 560 may also include an earphone jack to provide communication between a peripheral earphone and the electronic device 500.

Electronic device 500 can help users receive requests, send information, etc. through transmission module 570 (a Wi-Fi module), providing users with wireless broadband Internet access. Although the transmission module 570 is shown in the figure, it can be understood that it does not belong to the essential configuration of the electronic device 500 and can be omitted as needed without changing the essence of the invention.

Processor 580 is the control center of the electronic device 500, connecting various parts of the entire phone through various interfaces and lines, by running or executing software programs and/or modules stored in memory 520, and invoking data stored in memory 520, to perform various functions of the electronic device 500 and process data, thereby overall monitoring the electronic device. Optionally, processor 580 may include one or more processing cores; in some embodiments, processor 580 may integrate an invention processor and a modem processor, where the invention processor mainly processes operating systems, user interfaces, inventions, etc., and the modem processor mainly processes wireless communication. It can be understood that the above-mentioned modem processor may also not be integrated into processor 580.

Electronic device 500 also includes a power supply 590 (such as a battery) that supplies power to various components. In some embodiments, the power supply can be logically connected to processor 580 through a power management system, thereby realizing functions such as managing charging, discharging, and power consumption through the power management system. Power supply 590 may also include one or more DC or AC power sources, a recharging system, a power failure detection circuit, a power converter or inverter, a power status indicator, and any other components.

Although not shown, the electronic device 500 also includes a camera (such as a front camera, a rear camera), a Bluetooth module, etc., which will not be repeated here. Specifically, in this embodiment, the display unit of the electronic device is a touch screen display, the mobile terminal further includes a memory, and one or more programs, wherein the one or more programs are stored in the memory and configured to be executed by one or more processors, the one or more programs containing instructions for performing the following operations:
acquiring first point cloud data of a workpiece before grinding and second point cloud data of the workpiece after grinding;
obtaining an unground portion based on the first point cloud data and the second point cloud data, and performing registration on the unground portion to obtain a transformation matrix;
obtaining registered third point cloud data based on the first point cloud data and the transformation matrix;
projecting the third point cloud data and the second point cloud data to obtain a first discrete projection point set and a second discrete projection point set;
performing B-spline curve fitting on the first discrete projection point set and the second discrete projection point set to obtain a first B-spline curve and a second B-spline curve;
calculating the grinding allowance based on the first B-spline curve and the second B-spline curve.

During specific implementation, each of the above modules can be implemented as an independent entity, or combined arbitrarily as one or several entities. The specific implementation of each of the above modules can refer to the preceding method embodiments, which will not be repeated here.

Those of ordinary skill in the art can understand that all or part of the steps in the various methods of the above embodiments can be completed by instructions, or by instructions controlling relevant hardware, and the instructions can be stored in a computer-readable storage medium and loaded and executed by a processor. To this end, an embodiment of the present invention provides a storage medium, wherein a plurality of instructions are stored, and the instructions can be loaded by a processor to execute the steps in any embodiment of the method for calculating grinding allowance of workpiece in laser cladding additive manufacturing provided by the embodiments of the present invention.

Wherein, the computer-readable storage medium may include: read-only memory (ROM), random access memory (RAM), magnetic disk, or optical disk, etc.

Since the instructions stored in the storage medium can execute the steps in any embodiment of the method for calculating grinding allowance of workpiece in laser cladding additive manufacturing provided by the embodiments of the present invention, the beneficial effects achievable by any method for calculating grinding allowance of workpiece in laser cladding additive manufacturing provided by the embodiments of the present invention can be achieved. For details, refer to the preceding embodiments, which will not be repeated here.

The above describes in detail a method, apparatus, storage medium, and electronic device for calculating grinding allowance of workpiece in laser cladding additive manufacturing provided by the embodiments of the present invention. Specific examples are used in this specification to illustrate the principles and implementation methods of the present invention. The description of the above embodiments is only used to help understand the method and core ideas of the present invention; at the same time, for those skilled in the art, according to the ideas of the present invention, there will be changes in the specific implementation methods and invention scope. In summary, the content of this specification should not be construed as limiting the present invention.

What is claimed is:

1. A method for calculating grinding allowance of workpiece in laser cladding additive manufacturing, comprises:
acquiring first point cloud data of a workpiece before grinding and second point cloud data of the workpiece after grinding;
obtaining an unground portion based on the first point cloud data and the second point cloud data, and performing registration on the unground portion to obtain a transformation matrix;
obtaining registered third point cloud data based on the first point cloud data and the transformation matrix;
projecting the third point cloud data and the second point cloud data to obtain a first discrete projection point set and a second discrete projection point set;
performing B-spline curve fitting on the first discrete projection point set and the second discrete projection point set to obtain a first B-spline curve and a second B-spline curve;
calculating the grinding allowance based on the first B-spline curve and the second B-spline curve.

2. The method for calculating grinding allowance of workpiece in laser cladding additive manufacturing of claim 1, projecting the third point cloud data and the second point cloud data to obtain a first discrete projection point set and a second discrete projection point set, comprises:
randomly selecting a plurality of points in the third point cloud data to calculate a corresponding first plane equation;
generating a first auxiliary plane and a second auxiliary plane based on a first fitting plane corresponding to the first plane equation;
counting the number of point clouds contained in a space between the first auxiliary plane and the first fitting plane, and in a space between the second auxiliary plane and the first fitting plane;
traversing point clouds in the space on the side with a smaller number of point clouds, and for any point pᵢ, finding a nearest neighbor point pⱼ of pᵢ in the point clouds on the other side, connecting pᵢpⱼ, and calculating an intersection point of pᵢpⱼ with the first fitting plane as a projection point;
repeating the above steps to obtain a plurality of projection points, forming the first discrete projection point set.

3. The method for calculating grinding allowance of workpiece in laser cladding additive manufacturing of claim 1, projecting the third point cloud data and the second point cloud data to obtain a first discrete projection point set and a second discrete projection point set, comprises:
randomly selecting a plurality of points in the second point cloud data to calculate a corresponding second plane equation;
generating a third auxiliary plane and a fourth auxiliary plane based on a second fitting plane corresponding to the second plane equation;
counting the number of point clouds contained in a space between the third auxiliary plane and the second fitting plane, and in a space between the fourth auxiliary plane and the second fitting plane;
traversing point clouds in the space on the side with a smaller number of point clouds, and for any point qᵢ, finding a nearest neighbor point qⱼ of qᵢ in the point clouds on the other side, connecting qᵢqⱼ, and calculating an intersection point of qᵢqⱼ with the second fitting plane as a projection point;
repeating the above steps to obtain a plurality of projection points, forming the second discrete projection point set.

4. The method for calculating grinding allowance of workpiece in laser cladding additive manufacturing of claim 2, generating a first auxiliary plane and a second auxiliary plane based on a first fitting plane corresponding to the first plane equation comprises:
using the first fitting plane corresponding to the first plane equation as a reference, translating the first fitting plane by a first distance toward both sides respectively to obtain the first auxiliary plane and the second auxiliary plane.

5. The method for calculating grinding allowance of workpiece in laser cladding additive manufacturing of claim 1, performing B-spline curve fitting on the first discrete projection point set and the second discrete projection point set to obtain a first B-spline curve and a second B-spline curve, comprises:
for the second discrete projection point set, setting an order k and a node vector {u₀, u₁, . . . , uₘ}, and establishing a B-spline curve equation:
$$C ( u ) = {\sum }_{i = 0}^{n} {P}_{i} {B}_{i , k} ( u )$$
wherein, Pᵢ is a control point, B_{i,k}(u) is a B-spline basis function, the length of the node vector is m+1, the number of control points n+1 and the order k have the following relationship:
$$m = n + k + 1$$
a recursive relation for the basis function B_{i,k}(u) of any order k is:
$${B}_{i , k} ( u ) = \frac{u - {u}_{i}}{{u}_{i + {k}^{-}} {u}_{i}} {B}_{i , k - 1} ( u ) + \frac{{u}_{i + k + {1}^{-}} u}{{u}_{i + k + {1}^{-}} {u}_{i + 1}} {B}_{i + 1 , k - 1} ( u )$$
defining an error calculation function E:
$$E = {\sum }_{j = 1}^{m} {‖ {Q}_{j} - C ( {u}_{j} ) ‖}^{2}$$
using a least squares method to optimize the control points {Pᵢ}, to obtain the second B-spline curve C(u).

6. The method for calculating grinding allowance of workpiece in laser cladding additive manufacturing of claim 1, calculating the grinding allowance based on the first B-spline curve and the second B-spline curve, comprises:
selecting a plurality of uniformly distributed parameter values on the first B-spline curve and the second B-spline curve, and determining a first corresponding point on the first B-spline curve and a second corresponding point on the second B-spline curve for each parameter value;
determining a tangent direction at the second corresponding point;
calculating a distance from the first corresponding point to the tangent line at the second corresponding point as the grinding allowance of the first corresponding point;
repeating the above steps to calculate the grinding allowance for all sampling points, obtaining a complete grinding allowance of the workpiece.

7. The method for calculating grinding allowance of workpiece in laser cladding additive manufacturing of claim 6, calculating a distance from the first corresponding point to the tangent line at the second corresponding point as the grinding allowance of the first corresponding point, comprises:
calculating the grinding allowance using a first formula, the first formula being:
$${d}_{i} = ‖ D - ( D \cdot t ) \cdot t ‖$$
wherein, D=qᵢ−pᵢ, qᵢ is the first corresponding point, pᵢ is the second corresponding point, dᵢ is the grinding allowance, and t is the tangent direction at the second corresponding point.

8. An apparatus for calculating grinding allowance of workpiece in laser cladding additive manufacturing, comprising:
a point cloud acquisition module, configured to acquire first point cloud data of a workpiece before grinding and second point cloud data of the workpiece after grinding;
a first processing module, configured to obtain an unground portion based on the first point cloud data and the second point cloud data, and perform registration on the unground portion to obtain a transformation matrix;
a second processing module, configured to obtain registered third point cloud data based on the first point cloud data and the transformation matrix;
a projection module, configured to project the third point cloud data and the second point cloud data to obtain a first discrete projection point set and a second discrete projection point set;
a B-spline curve fitting module, configured to perform B-spline curve fitting on the first discrete projection point set and the second discrete projection point set to obtain a first B-spline curve and a second B-spline curve;
a grinding allowance calculation module, configured to calculate the grinding allowance based on the first B-spline curve and the second B-spline curve.

9. A computer-readable storage medium, the computer-readable storage medium storing a plurality of instructions, the instructions being adapted to be loaded by a processor to execute the method for calculating grinding allowance of workpiece in laser cladding additive manufacturing described in the claim 1.

10. A computer-readable storage medium, comprising a processor and a memory, the processor being electrically connected to the memory, the memory being configured to store instructions and data, and the processor being configured to execute the steps in the method for calculating grinding allowance of workpiece in laser cladding additive manufacturing described in the claim 1.
